(19) United States
(12) Patent Application Publication
(10) Pub. No.: US 2014/0089154 A1
(43) Pub. Date: Mar. 27, 2014

(54) COLORED CARD SCROLLER

(71) Applicant: Egan Schulz, San Jose, CA (US)

(72) Inventor: Egan Schulz, San Jose, CA (US)

(21) Appl. No.: 13/971,645

(22) Filed: Aug. 20, 2013

Related U.S. Application Data
(60) Provisional application No. 61/703,950, filed on Sep. 21, 2012.

(51) Int. Cl. G06Q 20/22

(52) U.S. Cl. CPC G06Q 20/227
USPC 705/35

(57) ABSTRACT

An online account provider displays cards associated with a user account according to the dominant color of the card, along with a corresponding color spectrum to enable the user to select a card based on the color. The user may see available cards linked to the user's account within the user's online or digital wallet or account along a first column based on color. A second column shows text information about the cards, such as name, type, balance, account number, etc. A third column shows a color spectrum with a scroll bar that enables the user to scroll to a particular color and see cards in and around that color in the spectrum. The color spectrum is built from the displayed cards, so that the color spectrum may be different for different users with different cards.

### CROSS REFERENCE TO RELATED APPLICATION

Pursuant to 35 U.S.C. §119(e), this application claims priority to the filing date of U.S. Prov. Pat. Appl. Ser. No. 61/703,950, filed Sep. 21, 2012, which is incorporated by reference in its entirety.

### BACKGROUND

1. Technical Field

The present application generally relates account display and more particularly to displaying cards for a user account.

2. Related Art

More and more users have online accounts, such as payment accounts, through service/payment providers. These online accounts have an ever-increasing number of information stored or associated with a user account. Information includes multiple funding instruments, loyalty cards, reward cards, and the like.

With these large numbers of cards, it may be difficult for a user to navigate, find, or view a desired card.

### BRIEF DESCRIPTION OF THE DRAWINGS

FIG. 1 is a flowchart showing a process an online account provider makes in creating a colored card scroller display for a user according to one embodiment;

FIG. 2 is a user display of the colored card scroller according to one embodiment;

FIG. 3 is block diagram of a networked system suitable for implementing the process described herein according to an embodiment; and

FIG. 4 is a block diagram of a computer system suitable for implementing one or more components in FIG. 3 according to one embodiment.

### DETAILED DESCRIPTION

In one embodiment, a user may see available cards linked to the user's account within the user's online or digital wallet or account. Cards may include credit cards, debit cards, loyalty cards, reward cards, gift cards, store cards, etc. The online account provider may display each card in a dominant color of the card, such as by sampling the colors of the card and/or determining a typical, average, or dominant color of the specific card. In one embodiment, a picture of the card is taken, and the image is sampled, looking for the dominant color (a type of color mathematical averaging). In another embodiment, an image of the card (either a physical card or a digital card) may be obtained from the card issuer's database or other suitable source. The card is then displayed in the correct order in the spectrum based on that dominant color. However, the card still looks exactly like the real user card. For example, the dominant color of a Home Depot® card may be orange, but the displayed image of the card looks like the actual user card and not just an orange card.

The user display, which can be on a PC, smart phone, computing tablet, or other display device, shows the cards in a first column arranged by their order in a color spectrum. A second column shows text information about the cards, such as name, type, balance, account number, etc. A third column shows a color spectrum with a scroll bar that enables the user to scroll to a particular color and see cards in and around that color in the spectrum. The color spectrum is built from the displayed cards, so that the color spectrum may be different for different users with different cards. Due to the visual color nature of the display, a user may scroll to find cards quickly, while having a pleasant visual experience.

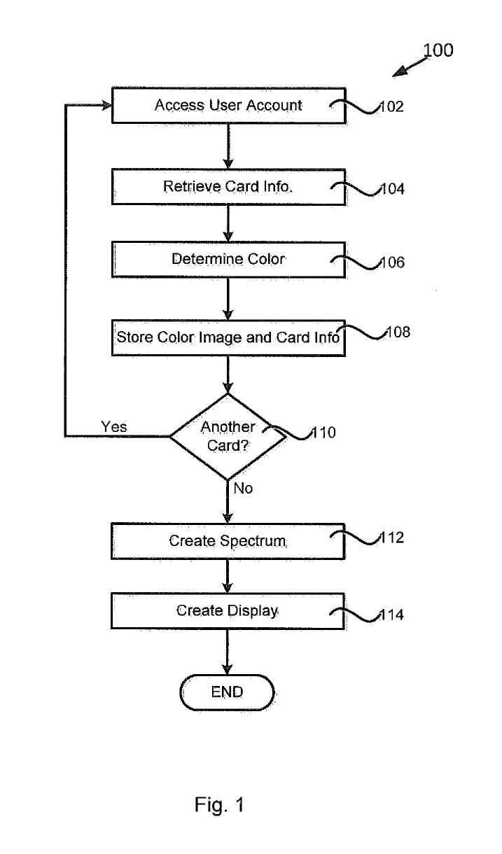

FIG. 1 is a flowchart 100 showing a process performed by an online account provider in creating a colored card scroller display for a user according to one embodiment. At step 102, the account provider, such as PayPal®, Inc. of San Jose, Calif., accesses a user account. A user may be viewed as someone who has registered with the account provider to utilize services provided by the account provider. Services may include financial services that the user utilizes to make payments, such as for purchase, donations, gifts, transfers, etc., or to receive payments, such as from merchants, friends, etc. As such, the user has at least one card for making payments, also known as a funding source or funding instrument. The user may also have non funding source cards, such as loyalty cards, identification cards, membership cards, and the like.

Next, at step 104, information about cards associated or linked with the user account is retrieved. If multiple cards are linked or associated with the user account, a first one is selected, either randomly or in some sort of order, such as cards used, accessed, or viewed most often by the user. For example, payment or funding cards may be selected first, with the primary funding source or most used fund card selected first. Non-funding cards may be grouped together next, with cards at the user's most frequently visited or shopped merchants selected first. Identification or any remaining cards may then be grouped together, with most commonly viewed cards being selected first, such as a driver's license or a health club membership card. Examples of cards include differently branded bank or debit cards, differently branded store gift cards, differently branded credit cards, differently branded store loyalty cards, differently branded membership cards, different types of identification cards, etc.

Depending on the type of card, the information about the card may be different. For example, for a debit card, information may include the bank or card issuer, account number, expiration date, CCV number, and name on the card. For a gift card, information may include the merchant or store name for the card, an amount on the card, and an expiration date, if any. For a credit card, information may include the credit card issuer name, account number, expiration date, CCV, name on the card, and type (such as Gold, Platinum, etc.). For an identification card, such as a driver's license, information may include the card (or driver license) number, name, date of birth, and expiration. For a loyalty or reward card, information may include the store or merchant name, loyalty/reward number, and name on the card. For a membership card, information may include the store/merchant name, the membership number, expiration date, type of membership (e.g., Gold, Basic, etc.), and any membership restrictions, such as to services, discounts, locations, and the like.

For the card for which the information is retrieved, a card color is determined, at step 106. Each specific card typically may have a specific color and design. For example, Home Depot® cards are generally orange, driver's licenses are generally white with a color for a specific state, Costco® cards are generally red and blue with a white or black background (for executive membership), etc. Credit cards may have different colors, even if from the same card issuer. For example, a Gold American Express® card is generally gold, a Platinum American Express® card is generally platinum or silver, a Hilton Honors® American Express® card is generally bronze, and a Starwood® American Express® card is generally scarlet. The specific card color can be determined from a database storing such information, a search of the web, information from the card provider, information from the user (such as from a photo taken of the card), and/or other means. For example, an average of the color of available cards of the specific type may be used. The average color may not be the dominant color, but rather the most representative or indicative color. For example, red may be the “average” color of a Costco® card, even though white or black may be the dominant or most used color as the background, since red is used to spell out Costco®.

Once relevant card information and color is obtained, a color visual representation or image of the card is stored with the card information and dominant color, at step 108. The color visual representation or image may be obtained from images of the card available on the Internet, from a user supplied photo of the card, or from a re-creation of the card. The re-creation may contain enough description to clearly convey to the specific card type to the user. For example, the representation of the Costco® card may be a rectangular shape with a white background and Costco® spelled out in red lettering. Additional may be included, such as expiration date or the like.

A determination is made, at step 110, whether there are any more cards in the user's account. If so, the next card is retrieved, at step 104. The process continues until all user cards in the user's account have been stored with a color image and assigned or average color.

When all the card color images and colors have been stored, a color spectrum is created at step 112. The color spectrum is based on the range of colors for the stored cards. In one embodiment, the color spectrum is based on the average color assigned or associated with a card. In another embodiment, the color spectrum is based on the predominant color of the actual card or color visual representation of the card. The spectrum may start with a full color spectrum that starts with the first color in the spectrum, e.g., the spectrum would go from violet to blue to green to yellow to orange to red. In another embodiment, the spectrum includes only colors and color transitions of the colors (average or associated) of all the cards associated or linked with the user account, such that if the user's cards only range from blue to yellow, the spectrum would not include any violet, orange, or red colors and would start with blue and end with yellow. For another user, the spectrum may go from violet to yellow to orange to red if the user does not have any blue or green colored cards. Thus, each user's color spectrum may be unique to that user. As the user adds and/or deletes cards, the spectrum can change accordingly. In yet another embodiment, the color spectrum may start with the color of the most used card, as opposed to starting with violet or other subsequent colors from a standard full color spectrum. For example, if the Home Depot® card is the most used, accessed, or viewed by the user, the color spectrum may start with orange, and then go to red, violet, blue, green and yellow for a full spectrum or less colors for a spectrum based only on cards in the user account.

Once the color spectrum for the cards has been created or determined, a display is created, at step 114. The display, which the user may see when the user accesses the user's account, may have a color image of each card, a description of each card, and a color spectrum scroll bar, in one embodiment. As such, the user may select a desired portion of the color spectrum or scroll to the desired portion and see cards associated with the color or range selected.

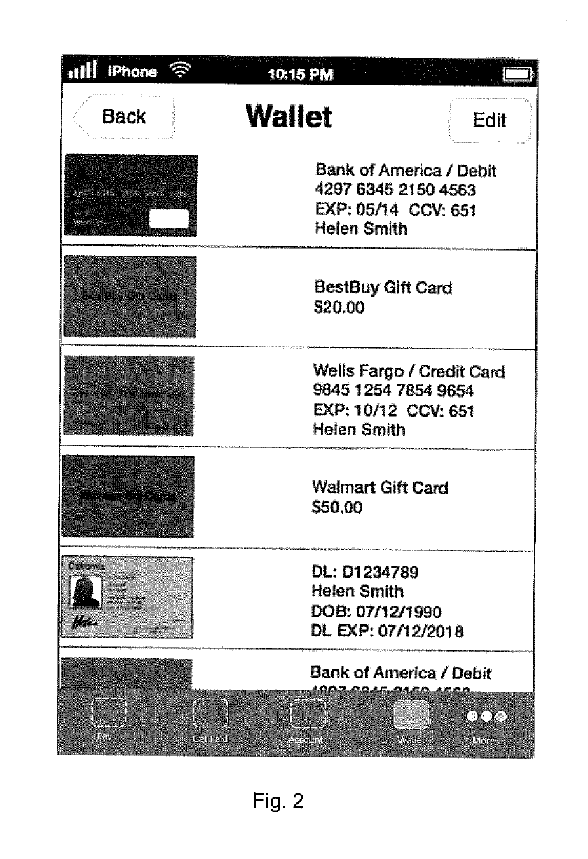

FIG. 2 shows one example of a colored card display. In the example, five full cards and one partial card are shown in the user's digital wallet within the user's online account with the payment provider. The five full cards shown are a purple first Bank of America® debit card, a blue BestBuy® gift card for $20, a turquoise Wells Fargo® credit card, a green Walmart® gift card for $50, and an orange California driver's license. The partial sixth card is a red second Bank of America® debit card. These are shown in color and in order of the color spectrum in a column on the left of the display. The order of the cards can vary, such as depending on user preferences or system preferences. In one embodiment, the order is based on the color of the most popular, most accessed, most viewed, most used (all generally referred to as most used), or the card specified by the user to be on top. For example, the user may select the first Bank of America® debit card to put on top for any reason, including color/look, most used, most viewed, currently most used or will be used, expiring the soonest, etc.

The system may select the first Bank of America® debit card because it is the color (violet) of the first color in the color spectrum or because it is the most viewed or used (e.g., the primary funding source for the user account) by the user. Once the top card is selected, the rest of the cards are arranged based on next colors in the color spectrum. Thus, “popularity” of cards would no longer be a factor, as a very seldom used card may be the next card displayed because it is the card having a color or average color that is next in the color spectrum after the color of the top card. If two cards have the same or approximately the same average color, the selection of which card to display first may be random or based on any number of criteria. For example, the more popular card may be shown first, the one expiring soonest may be shown first, the card name starting earlier in the alphabet may be shown first, or the card having the higher value may be shown first.

In a next column, the display shows textual information about each card. The textual information may be selected by the user or by the system/service provider. For example, relevant information for a credit or debit card displayed, such as the account number, expiration date, and security code. Additional information may include next payment due date, current balance, etc. For different types of cards, different information may be displayed. For example, with a gift card, the information may include the name of the merchant, the expiration date of the gift card, and the amount remaining on the gift card. Any restrictions may also be shown, such as qualifying locations or purchases. A driver's license may show the license number, name, date of birth, and expiration date. A loyalty card may show a loyalty account number, the merchant, expiration date (if any), and rewards earned or how close the user is to earning a next reward. A membership card may show where the membership is to or for, a membership number, expiration date, type of membership, and/or other information such as membership privileges and membership due date. An insurance card may show the type of insurance, the insurance carrier, names or identifiers of insured(s), coverage summaries/limits, policy number, expiration date, and number to call for coverage questions or for reporting an incident. Other examples of cards associated or linked with a user account may also be suitable.

In another column of the display, a color spectrum scroll bar is shown that allows the user to scroll to a color or range and see the cards in that color or range. The user may select a particular portion of the color spectrum, such as by tapping with a finger, clicking with a mouse or pointer, or other means. Once selected, card(s) having the selected color or color range are shown at the top of the display, with associated textual information. In one embodiment, the card that is closest in average color to the selected color is shown on top, and cards with colors following the selected color on the color spectrum are shown below the top card. In another embodiment, cards at or immediately before or after the selected color are shown on the top, with cards with colors following the selected color displayed below.

In one embodiment, the color spectrum scroll bar is displayed in full, i.e., all colors of cards represented, even though not all cards are displayed. For example, if the user has ten cards associated or linked with the user account, only four cards may be able to be displayed at one time for the user to see, but the user will still be able to see the color spectrum scroll bar that has colors of all ten cards represented. In this way, when the user selects a desired color or color range on the color spectrum scroll bar, the desired cards corresponding to the selected color or range will be moved (if needed) onto the display window for the user to see. Note that the color spectrum scroll bar, shown as a vertical bar in FIG. 2, may be horizontal or in another orientation as suitable. For example, if the device display was circular, such as with a smart watch, the color spectrum scroll bar may be an arc shape. If the device display has a triangular shape, the color spectrum scroll bar may be diagonal.

Thus, the user is able to use the color spectrum scroll bar, which may have different color spectrums for different users and different orientations for different displays, to quickly view a desired card or cards. The user can then select the card, such as by tapping or clicking. The selected card can be edited, selected for payment, or other applicable uses with or within the user's account.

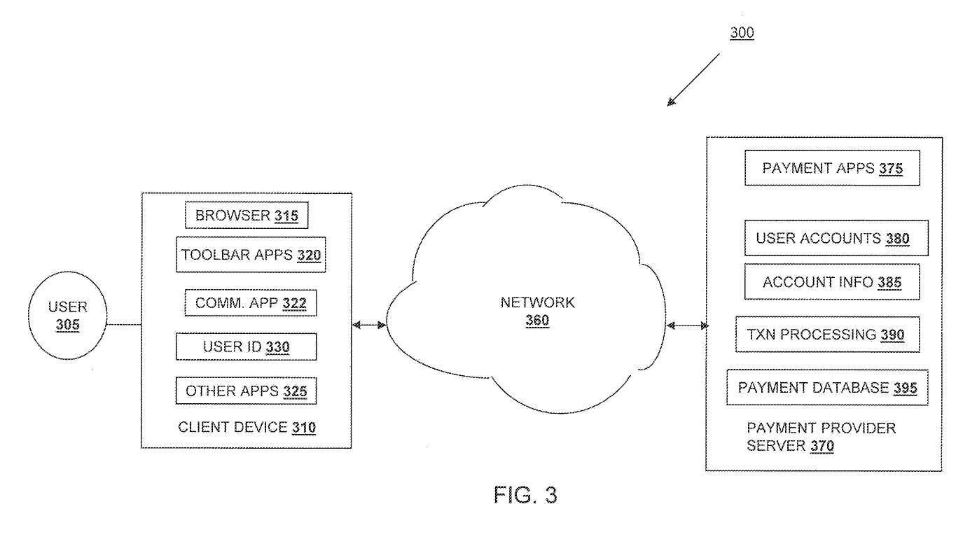

FIG. 3 is a block diagram of a networked system 300 configured to create a colored card scroller display on a user device, such as described above, in accordance with an embodiment of the invention. System 300 includes a user device 310 and a payment provider server 370 in communication over a network 360. Payment provider server 370 may be maintained by a payment provider, such as PayPal®, Inc. of San Jose, Calif. A user 305 utilizes user device 310 to view account information and perform transaction using payment provider server 370. Note that transaction, as used herein, refers to any suitable action performed using the user device, including payments, transfer of information, display of information, etc. Although only server is shown, a plurality of servers may be utilized. Exemplary servers may include, for example, stand-alone and enterprise-class servers operating a server OS such as a MICROSOFT® OS, a UNIX® OS, a LINUX® OS, or other suitable server-based OS. One or more servers may be operated and/or maintained by the same or different entities.

User device 310 and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks. For example, in various embodiments, network 360 may include the Internet or one or more intranets, landline networks, wireless networks, and/or other appropriate types of networks.

User device 310 may be implemented using any appropriate hardware and software configured for wired and/or wireless communication over network 360. For example, in one embodiment, the user device may be implemented as a personal computer (PC), a smart phone, personal digital assistant (PDA), laptop computer, a wearable such as a smart watch, and/or other types of computing devices capable of transmitting and/or receiving data, such as an iPad™ from Apple™.

User device 310 may include one or more browser applications 315 which may be used, for example, to provide a convenient interface to permit user 305 to browse information available over network 360. For example, in one embodiment, browser application 315 may be implemented as a web browser configured to view information available over the Internet, such as cards linked to or associated with a user account. User device 310 may also include one or more toolbar applications 320 which may be used, for example, to provide client-side processing for performing desired tasks in response to operations selected by user 305. In one embodiment, toolbar application 320 may display a user interface in connection with browser application 315 as further described herein.

User device 310 may further include other applications 325 as may be desired in particular embodiments to provide desired features to user device 310. For example, other applications 325 may include security applications for implementing client-side security features, programmatic client applications for interfacing with appropriate application programming interfaces (APIs) over network 360, or other types of applications. Applications 325 may also include email, texting, voice and IM applications that allow user 305 to send and receive emails, calls, and texts through network 360, as well as applications that enable the user to communicate, transfer information, make payments, and otherwise add, revise, delete and view cards in a wallet through the payment provider as discussed above. User device 310 includes one or more user identifiers 330 which may be implemented, for example, as operating system registry entries, cookies associated with browser application 315, identifiers associated with hardware of user device 310, or other appropriate identifiers, such as used for payment/user/device authentication. In one embodiment, user identifier 330 may be used by a payment service provider to associate user 305 with a particular account maintained by the payment provider as further described herein. A communications application 322, with associated interfaces, enables user device 310 to communicate within system 300.

Payment provider server 370 may be maintained, for example, by an online payment service provider which may provide payment between user 305 and the operator of merchant server 340. In this regard, payment provider server 370 includes one or more payment applications 375 which may be configured to interact with user device 310 and/or merchant server 340 over network 360 to facilitate the purchase of goods or services, communicate/display information, and send payments by user 305 of user device 310 and as discussed above.

Payment provider server 370 also maintains a plurality of user accounts 380, each of which may include account information 385 associated with consumers, merchants, and funding sources, such as credit card companies. For example, account information 385 may include private financial information of users of devices such as account numbers, passwords, device identifiers, user names, phone numbers, credit card information, bank information, identification cards, membership cards, loyalty cards, insurance cards or other information which may be used to facilitate transactions by user 305.

A transaction processing application 390, which may be part of payment application 375 or separate, may be configured to receive information from a user device and/or merchant server 340 for processing and storage in a payment database 395. Transaction processing application 390 may include one or more applications to process information from user 305 for processing an order and payment using various selected funding instruments or cards. As such, transaction processing application 390 may store details of an order from individual users, including funding source(s) used, credit options available, etc. Payment application 375 may be further configured to determine the existence of and to manage accounts for user 305, as well as create new accounts if necessary or add new cards.

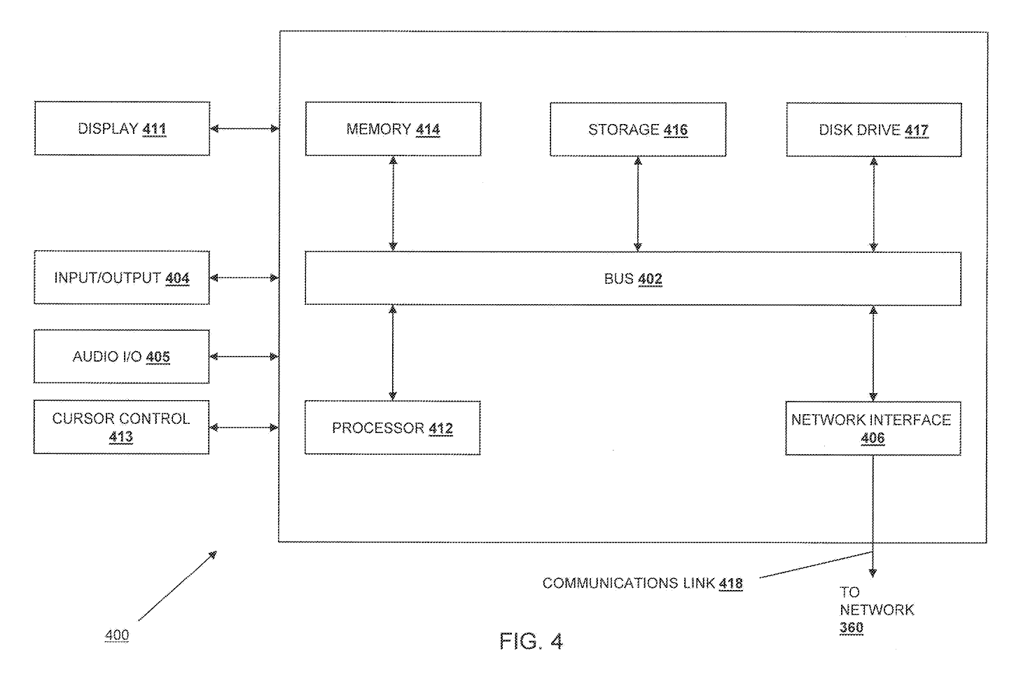

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, wearable, etc.) capable of communicating with the network. The payment provider may utilize a network computing device (e.g., a network server) capable of communicating with the network. It should be appreciated that each of the devices utilized by users and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may include a camera or other image capture device for capturing an image of a user card. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account information, wherein the information comprises a plurality of cards associated with a user account and at least a color corresponding to each of the plurality of cards; and
one or more hardware processors in communication with the non-transitory memory and configured for:
receiving, from a user through a user device, a color selected from a color scroll bar displayed on the user device corresponding to colors of cards associated with the user account; and
communicating, to the user device, a display comprising at least one card image corresponding to the color selected and the color scroll bar.

2. The system of claim 1, wherein the one or more hardware processors is further configured for:
retrieving information for a plurality of cards linked to the user account;
determining a color for each of the plurality of cards;
storing a card image and card information for each of the plurality of cards; and
creating a color spectrum based on the colors of the plurality of cards.

3. The system of claim 1, wherein a color at an initial end of the color scroll bar corresponds to a color of a card most used by the user.

4. The system of claim 1, wherein the cards comprises one or more of funding cards, membership cards, loyalty cards, insurance cards, and/or identification cards.

5. The system of claim 1, wherein the display further comprises textual information about the cards.

6. The system of claim 1, wherein the display further comprises additional cards corresponding to colors following the color selected on a standard color spectrum.

7. The system of claim 1, wherein the color scroll bar is vertical within the display.

8. The system of claim 1, wherein the color scroll bar comprises colors corresponding to colors of all cards associated with the user account and the display shows less than all cards associated with the user account.

9. A method comprising:
receiving, by a hardware computer processor from a user device, a color selected from a color scroll bar displayed on the user device corresponding to colors of cards associated with a user account; and
communicating, electronically by the hardware computer processor to the user device, a display comprising at least one card image corresponding to the color selected and the color scroll bar.

10. The method of claim 9, further comprising:
retrieving information for a plurality of cards linked to the user account;
determining a color for each of the plurality of cards;
storing a color image and card information for each of the plurality of cards; and
creating a color spectrum based on the colors of the plurality of cards.

11. The method of claim 9, wherein a color at an initial end of the color scroll bar corresponds to a color of a card most used by the user.

12. The method of claim 9, wherein the cards comprises one or more of funding cards, membership cards, loyalty cards, insurance cards, and/or identification cards.

13. The method of claim 9, wherein the display further comprises textual information about the cards.

14. The method of claim 9, wherein the display further comprises additional cards corresponding to colors following the color selected on a standard color spectrum.

15. The method of claim 9, wherein the color scroll bar comprises colors corresponding to colors of all cards associated with the user account and the display shows less than all cards associated with the user account.

16. A non-transitory computer readable medium comprising a plurality of machine-readable instructions which when executed by one or more processors of a server are adapted to cause the server to perform a method comprising:
receiving, from a user device, a color selected from a color scroll bar displayed on the user device corresponding to colors of cards associated with a user account; and
communicating, to the user device, a display comprising at least one card image corresponding to the color selected and the color scroll bar.

17. The non-transitory computer readable medium of claim 16, wherein the method further comprises:
retrieving information for a plurality of cards linked to the user account;
determining a color for each of the plurality of cards;
storing a color image and card information for each of the plurality of cards; and
creating a color spectrum based on the colors of the plurality of cards.

18. The non-transitory computer readable medium of claim 16, wherein a color at an initial end of the color scroll bar corresponds to a color of a card most used by the user.

19. The non-transitory computer readable medium of claim 16, wherein the cards comprises one or more of funding cards, membership cards, loyalty cards, insurance cards, and/or identification cards.

20. The non-transitory computer readable medium of claim 16, wherein the display further comprises textual information about the cards.

21. The non-transitory computer readable medium of claim 16, wherein the display further comprises additional cards corresponding to colors following the color selected on a standard color spectrum.

22. The non-transitory computer readable medium of claim 16, wherein the color scroll bar comprises colors corresponding to colors of all cards associated with the user account and the display shows less than all cards associated with the user account.
